(19) United States
(12) Patent Application Publication
(10) Pub. No.: US 2026/0369714 A1
(43) Pub. Date: Nov. 19, 2026

(54) Lithium-ion battery recycling and upcycling via Purification and Regeneration Integrated Materials Engineering (PRIME)

(71) Applicant: THE REGENTS OF THE UNIVERSITY OF CALIFORNIA, Oakland, CA (US)

(72) Inventors: Zheng CHEN, San Diego, CA (US); Weikang LI, La Jolla, CA (US); Varun GUPTA, La Jolla, CA (US)

(21) Appl. No.: 19/136,230

(22) PCT Filed: Dec. 5, 2023
(86) PCT No.: PCT/US2023/082571

§ 371 Date: Jun. 5, 2025

Related U.S. Application Data
(60) Provisional application No. 63/430,301, filed on Dec. 5, 2022.

(51) Int. Cl. H01M 10/54; H01M 10/0525

(52) U.S. Cl. CPC H01M 10/54; H01M 10/0525

(57) ABSTRACT

A process for direct recycling of Li-ion battery cathode material includes hydrothermally treating cathode black mass (CBM) in an alkaline solution to decompose polyvinylidene fluoride (PVDF) and remove electrolyte salts, washing the treated CBM in deionized water to remove extra alkaline solution, conductive carbon, degraded PVDF and impurities, and annealing the washed material for crystal structure repair and remnant carbon removal.

### RELATED APPLICATIONS

This application claims the benefit of the priority of U.S. Provisional Application No. 63/430,301, filed Dec. 5, 2022, which is incorporated herein by reference in its entirety.

### FIELD OF THE INVENTION

The present invention relates to recycling, recovery, and regeneration of materials from electrode scraps, cell scraps, and spent lithium-ion batteries.

### BACKGROUND

Exponential growth of lithium-ion batteries (LIBs) in consumer electronics in last few decades has raised concerns on dealing with the substantial amount of end-of-life (EoL) batteries translating from the high demand to avoid adverse environmental impacts. LIB's further expeditiously increasing demand for electric vehicles is also imposing stress on the supply chain for critical materials. A shortage of these critical materials, especially transition metals such as Ni and Co, may soon create a bottleneck for scaling the world's transition to battery powered vehicles. This rapid transformation creates an opportunity to promote a “waste to wealth” aspect of battery recycling, along with environmental friendliness, by setting up a local secondary supply chain for these materials. Direct recycling is one of the most promising solutions to obtain the highest value from EoL batteries because it restores the cathode active material (CAM) directly, keeping the target value product, while exhibiting low energy consumption and providing net greenhouse gas (GHG) emission offsets. There have been significant efforts to scale up and simplify this technology to match it with already established hydrometallurgy and pyrometallurgy techniques in industry. Some of the key technical challenges with direct recycling include rigorous preprocessing to remove binder/conductive carbon/aluminum shreds/electrolyte salt impurities and reliable regeneration of high purity crystal structure to meet industry standards, which constrains its industry adaptation.

Direct recycling of cathode materials has been demonstrated at lab scale where the cathode is processed in small quantities of few grams, and different pretreatment methods are commonly involved for purification. The cathodes obtained from the EoL batteries usually have different impurities including electrolyte salt (typically LiPF₆), conductive carbon (typically Super P65/P45), aluminum shreds, and binder (typically polyvinylidene fluoride (PVDF)), which may be referred to as “cathode black mass” (CBM). The impurity removal process is often referred to as “purification.” Heating or solvent washing are both verified as effective for impurity removal but have drawbacks. In a heating process, PVDF, conductive carbon, and LiPF₆ introduce fluorine and carbon into the reaction, which compromises the quality of the resulting cathode material. For instance, carbon on the surface when burnt would provide CO₂ environment which is well known to react with active surface oxygen anions, eventually leading to the formation of Li₂CO₃ and irreversible Li loss in the bulk. PVDF is known to be a low temperature fluorinating reagent for metal oxides and for that reason should be avoided. Fluorine compounds (PVDF and LiPF₆) during heating lead to formation of HF which acts as a dopant within the cathode material, substituting oxygen forming MF₂ (M=transition metal), or leads to irreversible Li loss by formation of LiF on the surface. Li loss should be avoided since it makes already Li-deficient cycled NMC based materials even more vulnerable to oxygen loss. This promotes rock salt phase formation causing high impedance at cell level. LiF also is fairly insoluble in water and its evaporation temperature is very high. Once formed, it is very hard to remove from the surface of the cathode and would increase impedance due to its low ionic conductivity (10⁻⁹ S/cm).

The alternative impurity removal process, solvent washing, is effective in removing different impurities. Electrodes can be soaked in dimethyl carbonate or other organic solvents to remove the electrolyte salt residual. Conductive carbon and PVDF are removed together by dissolution of the PVDF in toxic organic solvents such as N-Methyl-2-pyrrolidone (NMP), Dimethyl-formamide (DMF), Dimethylacetamide (DMAC), etc., liberating conductive carbon and active material in the solvent. Although solvent processing has high separation yield, organic solvent usage on a large scale raises significant environmental concerns and is subject to strict government regulation, making it unscalable. Other green solvent alternatives such as triethyl phosphate and Cyrene have been proposed, however, the extra solvents potentially lead to the new residuals on the cathode surface, and ultimately should be removed. In addition, the recycling industry commonly employs mechanical methods to separate CBM from aluminum foil such that trace amounts of Al shreds can remain within the CBM. The aluminum shreds can act as dopants in the CAM and have even been shown to improve the electrochemical performance. However, controlling the threshold dopant limit (0.4 wt. %) would be challenging on a large scale.

Accordingly, the need remains for a sustainable and environmentally sound battery recycling process that can be scaled to the industrial levels needed to support the world's mass transition to batteries as primary energy sources.

### SUMMARY

The inventive approach addresses the rapidly growing battery waste accumulation problem by integrating purification and relithiation processes for CBM, providing a recycling technology that is more environmentally friendly, cost-effective, and scalable. By purifying CBM from the unwanted binder, electrolyte residual, aluminum shreds, and conductive carbon, the resulting purified product can be integrated with existing relithiation and sintering steps. No organic solvent is needed in the inventive process in which a 100 g batch of CBM (NCM111) was successfully regenerated to its pristine state. With steps derived and designed from existing hydrothermal and sintering technologies used for cathode synthesis, the inventive process is safe and easily scalable to industrial levels. This process can be extended to NCM622, NCM811 (or higher nickel up to 99 wt. %), NCA, NCMA and mixed CBM in various states, while the chemical solutions can be reused to maximize process efficiency. The inventive approach clears one of the major challenges for scaling up of direct recycling in an ecofriendly and economical way, making it suitable for further industry adoption.

The inventive approach, referred to as “Purification and Regenerating Integrated Materials Engineering” or “PRIME,” provides complete recycling capability, including recovery and regeneration of materials from electrode scraps, cell scraps, and spent batteries, including cathode active materials (CAM) with different chemistries, e.g., LiCoO₂ (LCO), LiNiₓCo_{y}Mn_{z}O₂(x+y+z=1)(NCM or NMC), LiNiₓCo_{y}Al_{z}O₂ (NCA), LiMn₂O₄ (LMO), LiFePO₄ (LFP), LiMnₓFe_{y}PO₄ (LMFP), and others. Notwithstanding the fact that these varied cathode materials may involve different amounts of dopants, or may have surface coated layers, the recycled CAM produced by the inventive approach can be used to fabricate new batteries having equivalent electrochemical properties to the original.

Direct recycling methods often involve multiple complicated steps that increase both the degree of sophistication and costs of processing spent batteries, making these processes less economically viable and more challenging to scale. Compared to other direct recycling methods, the inventive approach offers an integrated process for recycling cathode materials that dramatically reduces the number of physical and chemical processing steps required, integrating purification and regeneration in one single step.

In one aspect, a method for direct recycling of Li-ion battery cathode material includes: hydrothermally treating cathode black mass (CBM) in a lithium ion-containing solution to decompose polyvinylidene fluoride (PVDF) and remove electrolyte salts; washing the treated CBM in a washing solution to remove extra lithium-ion containing solution, conductive carbon, degraded PVDF and impurities; and annealing the washed material for crystal structure repair and remnant carbon removal to recover cathode active material (CAM), wherein the CAM is usable to fabricate new batteries. In some embodiments, the lithium-ion containing solution may be one or a combination of LiOH, NaOH, KOH, an alkaline metal hydroxide solution, a water-soluble lithium salt, and an electrolyte salt. The lithium-ion containing solution may be an alkaline metal hydroxide solution comprising one or a combination of Li₂CO₃, Li acetate, Li₂SO₄. The lithium-ion containing solution may include an electrolyte salt comprising one or a combination of LiPF₆, LiBF₄, LiClO₄, Lithium bis(oxalato)borate (C₄BLiO₈), and Lithium difluoro(oxalato)borate (C₂BF₂LiO₄). The lithium-ion containing solution may have a lithium concentration within a range of from 0.1 to saturated at 25 °C. In some embodiments, the lithium-ion containing solution may be 0.1 to 5.34M LiOH. The step of hydrothermally treating includes subjecting the CBM in the lithium-ion containing solution to a temperature within a range of 50 to 300 °C for a duration ranging from 1 to 10 hrs. The washing step may include mechanically agitating the CBM in the washing solution. In some embodiments, the lithium-ion containing solution may be recaptured and reused solution from one or more prior hydrothermal treatment. The CBM may be one or more of NCM111, NCM622, NCM811, NCA, NCMA and mixed CBM.

In another aspect, a method for direct recycling of Li-ion battery cathode material may include: hydrothermally treating cathode black mass (CBM) in a treatment solution comprising an alkaline solution to decompose polyvinylidene fluoride (PVDF) and remove electrolyte salts and a lithium-ion solution to relithiate the CBM; washing the treated CBM in a washing solution to remove extra treatment solution, conductive carbon, degraded PVDF and impurities; and annealing the washed material for crystal structure repair and remnant carbon removal to recover cathode active material (CAM), wherein the CAM is usable to fabricate new batteries. In some embodiments, the treatment solution may be one or a combination of LiOH, NaOH, KOH, an alkaline metal hydroxide solution, a water-soluble lithium salt, and an electrolyte salt. The treatment solution may be an alkaline metal hydroxide solution comprising one or a combination of Li₂CO₃, Li acetate, Li₂SO₄. The treatment solution may include an electrolyte salt comprising one or a combination of LiPF₆, LiBF₄, LiClO₄, Lithium bis(oxalato)borate (C₄BLiO₈), and Lithium difluoro (oxalato) borate (C₂BF₂LiO₄). The treatment solution may have a lithium concentration within a range of from 0.1 to saturated at 25 °C. In some embodiments, the lithium-ion containing solution may be 0.1 to 5.34M LiOH. The step of hydrothermally treating includes subjecting the CBM in the treatment solution to a temperature within a range of 50 to 300 °C for a duration ranging from 1 to 10 hrs. The washing step may include mechanically agitating the CBM in the washing solution. In some embodiments, the treatment solution may be recaptured and reused solution from one or more prior hydrothermal treatment. The CBM may be one or more of NCM111, NCM622, NCM811, NCA, NCMA and mixed CBM.

Direct recycling of the active materials from spent batteries and manufacturing scraps would be highly desirable for battery recycling, in which the cathode mixture would be kept intact. Several challenges have hindered direct recycling development and scaling up, including impurity removal, batch uniformity, and scalability—all should be economically viable. As for the impurity removal, the binder in the cathode blackmass (CBM) is one of the biggest challenges. Polyvinylidene Fluoride (PVDF) is the most commonly used binder for cathode fabrication, which inherently holds together the active cathode material with the conductive carbon, conventional purification steps for directly recycling involve either dissolution or decomposition to remove PVDF, which will be either noneconomic or facing fluorine impurity (LiF) hardly removed. Batch uniformity is another challenge because cathode materials from different single cells usually own different SOC states after long-term cycling. The lithium supplement amount needs to be well controlled. Lastly, scalability is still problematic for direct recycling. PRIME uses an innovative approach to bridge the gap between lab-scale direct recycling and the current industrial recycling methods. PRIME is compatible with both spent batteries and manufacturing scraps. PRIME removes impurity; some components are dissolved while others are decomposed. PRIME relithiates the cathode materials with different lithium contents back to the same pristine lithium ratio. Most importantly, PRIME promises to be scalable to ton-level cathode recovery yields.

### BRIEF DESCRIPTION OF THE DRAWINGS

FIG. 1 is a diagram of an embodiment of the inventive process indicating scalable regeneration of CAM by Multistep Integrated Direct Recycling.

FIG. 2A is a schematic of the mechanism of binder decomposition and active material liberation; FIG. 2B plots FTIR spectrum showing chemical degradation of PVDF; and FIG. 2C plots the results of Thermogravimetric Analysis TGA of the CBM (NCM111) compared with cathode material recovered using the inventive process, estimating binder and carbon content.

FIGS. 3A-3C are SEM images of pCAM, CBM, and rCAM, respectively; FIG. 3D is a wide-angle SEM image of rCAM; FIG. 3E is a XRD comparison of pCAM, CBM, and rCAM, indicating bulk relithiation of the recovered material; FIG. 3F compares XPS spectra of fluorine in pCAM, CBM, and rCAM; FIG. 3G provides DTA and DSC data for CBM and rCAM; FIGS. 3H and 3I compare XPS data of for oxygen and carbon, respectively.

FIG. 4A is a plot of elemental analysis for carbon content comparison of pCAM and rCAM; FIG. 4B provides results of EDS analysis for aluminum tracking.

FIGS. 5A-5E show electrochemical performance of the regenerated cathode material, wherein FIG. 5A shows a voltage profile in 1st cycle; FIG. 5B plots cycling stability in a half cell; FIG. 5C shows extended cycling stability of the recovered cathode presented in a half cell; FIG. 5D plots rate performance of the regenerated cathode compared with pristine; and FIG. 5E plots cycling stability in full cell.

FIG. 6A provides a schematic representation of the reuse of the LiOH supplement solution in hydrothermal step; FIG. 6B plots first cycle voltage profile for recovered NCM111 (rCAM) in reused LiOH supplement solution; FIG. 6C is a comparison of (003) XRD peak data for different samples; and FIG. 6D shows the first cycle voltage profile for recovered NCM 622 (rCAM 622) using the inventive process.

FIG. 7A shows the initial cycle of pristine NCM811 (pCAM NCM811) and recovered NCM811 (rCAM NCM811), FIG. 7B and FIG. 7C provide the results for NCA and NCMA materials, respectively.

### DETAILED DESCRIPTION OF EMBODIMENTS

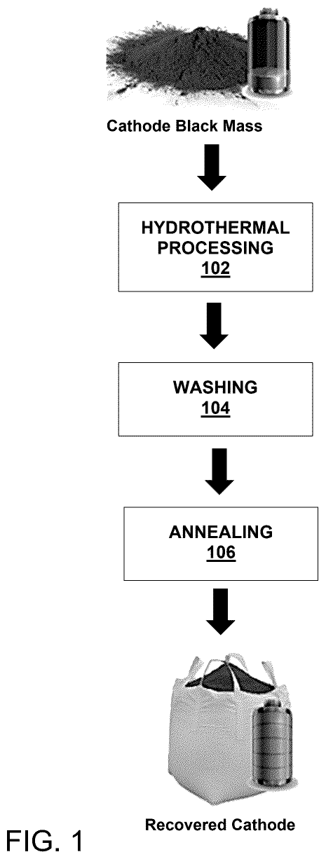

The inventive cathode recycling process, diagrammatically shown in FIG. 1, involves three main steps: (step 102) hydrothermal (“HT”) relithiation with PVDF decomposition and electrolyte salt removal; (step 104) washing, for extra alkaline solution, conductive carbon, degraded PVDF, and other impurity removal; and (step 106) annealing, for crystal structure repair and remnant carbon removal. As a comparison, a typical lab-scale direct recycling process includes multiple purification steps employing toxic organic solvents such as N-Methyl-2-pyrrolidone (NMP) and dimethyl carbonate (DMC) to dissolve PVDF binder and liberate the cathode material (sometimes employing sonication to expedite), plus centrifugation to separate conductive carbon from the cathode active material (CAM), making the overall process time consuming. Cathode electrode typically includes PVDF and carbon black as important inactive materials, however, such materials are usually not favorable in a recycling/upcycling process.

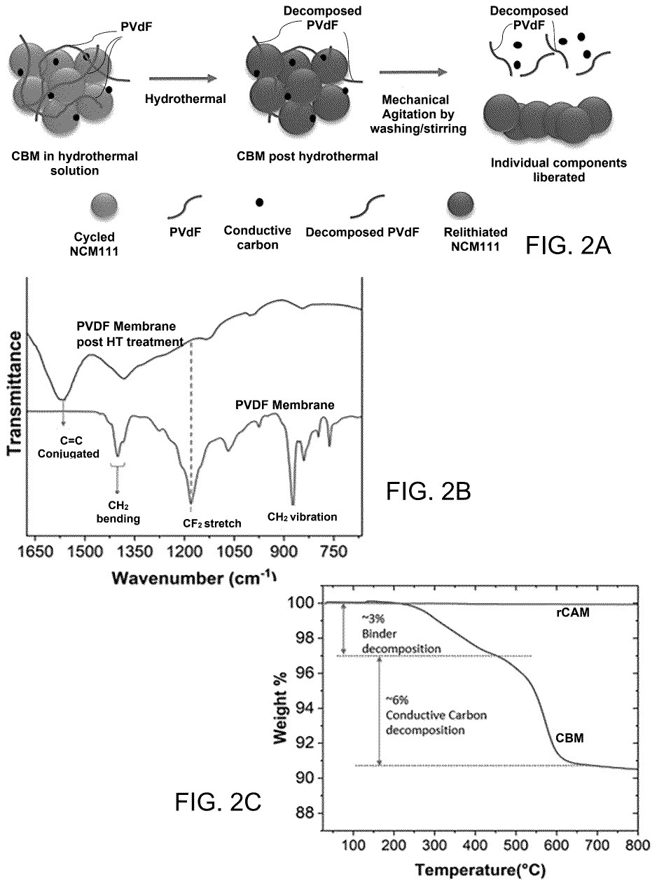

The mechanism of liberation of the cathode material that occurs in steps 102 and 104 is diagrammatically illustrated in FIG. 2A. To determine the mechanism of PVDF degradation during HT process, a pure PVDF membrane was fabricated by coating a glass plate with PVDF, drying it, and peeling it off of the glass plate. The transparent membrane was treated with HT reaction in an alkaline solution (e.g., 0.1 to 4M LiOH solution) under the same conditions commonly used for cathode HT relithiation, i.e., 220 °C for 4 hrs. After the reaction, the transparent PVDF membrane decomposed into a black fragile membrane. The mechanical integrity of the decomposed membrane product was completely lost as it disintegrated into powder during washing. Referring to FIG. 2B, Fourier-transform infrared spectra (FTIR) analysis of the dried decomposed membrane revealed that the characteristic fluorocarbon peaks (1000-1250 cm⁻¹) observed in the original PVDF membrane vanished while a broad peak for double bonded carbon appeared at 1600 cm⁻¹. This result is consistent with earlier studies that have suggested that PVDF membrane undergoes a defluorination reaction under alkaline environment. This result validated two key points: first, PVDF can be defluorinated/decomposed in the same HT conditions used for relithiation of cathode, and second, that the decomposed product loses its mechanical integrity to a sufficient degree that it can be easily broken by mild agitation during washing.

Variations on HT processing are known in the art as being effective for relithiation, including different combinations of temperatures, times, pressures, and atmospheres. For example, PCT Publication WO2023/164073, incorporated herein by reference, discloses a low temperature HT process for relithiation. Accordingly, the specific temperature and times cited herein are provided as examples of HT processing, with the key objective being that the PVDF be decomposed and other impurities substantially removed by the alkaline solvent used in the HT process and subsequent washing. Furthermore, HT processing is not limited to LiOH—a variety of different treatment solutions may be used to perform steps of relithiation and removal of electrolyte salts. The treatment solution may include one or a combination of LiOH, NaOH, KOH, an alkaline metal hydroxide solution, e.g., one or a combination of Li₂CO₃, Li acetate, Li₂SO₄., a water-soluble lithium salt, and an electrolyte salt, e.g., one or a combination of LiPF₆, LiBF₄, LiClO₄, Lithium bis(oxalato) borate (C₄BLiO₈), and Lithium difluoro (oxalato) borate (C₂BF₂LiO₄).

Cathode regeneration based on hydrothermal relithiation followed by a short post annealing step is widely reported in the field. Multiple workers have confirmed effective reconstruction of the morphology, composition, and crystal structure of spent LiCoO₂ (LCO), LiNi_{0.33}Co_{0.33}Mn_{0.33}O₂ (NCM111), LiNi_{0.5}Co_{0.2}Mn_{0.3}O₂ (NCM523), LiNi_{0.6}Co_{0.2}Mn_{0.2}O₂ (NCM622) and LiFePO₄ (LFP) cathodes, leading to the same level of electrochemical performance as their pristine materials. See, e.g., E. Gratz, et al., “A closed loop process for recycling spent lithium ion batteries”, Journal of Power Sources 262 (2014) 255-262; Y. Shi, et al., “Ambient-Pressure Relithiation of Degraded LiₓNi_{0.5}Co_{0.2}Mn_{0.3}O₂ (0<x<1) via Eutectic Solutions for Direct Regeneration of Lithium-Ion Battery Cathodes”, Adv. Energy Mater. 9 (2019) 1900454; S. Sloop, et al., “A direct recycling case study from a lithium-ion battery recall”, Sustainable Materials and Technologies 25 (2020) e00152; L. Brückner, et al., “Industrial Recycling of Lithium-Ion Batteries—A Critical Review of Metallurgical Process Routes”, Metals 10 (2020) 1107; Y. Shi, et al., “Effective regeneration of LiCoO₂ from spent lithium-ion batteries: A direct approach towards high-performance active particles”, Green Chem. 20 (2018) 851-862; and P. Xu, et al., “Efficient Direct Recycling of Lithium-Ion Battery Cathodes by Targeted Healing”, Joule 4 (2020) 2609-2626. Described methods feature simple operation and low energy consumption, taking advantage of the hydrothermal relithiation process to recover the cathode compositions without being concerned with variation of Li loss in different feedstocks of degraded LIBs. The processes also leverage the short sintering process to recover the cathode microstructure with desirable stoichiometry and crystallinity.

HT relithiation in an alkaline environment has been shown to be a vital step to regenerate cathode materials. The efficiency of the relithiation conditions can be further enhanced by employing the hydroxides in the solution to react with the PVDF binder on the side. The obtained CBM (NCM111) with 3 wt. % PVDF (suggested by Thermogravimetric Analysis (TGA) as shown in FIG. 2C) was directly treated in the same HT relithiation conditions for further treatment. Washing after hydrothermal treatment with deionized water (DI) (step 104) was employed to remove decomposed PVDF, alkaline, and carbon impurities. In some embodiments, other washing solutions may be used, for example, low-concentration alkaline solutions, and mild inorganic/organic acid solutions may be used in place of or in addition to DI water.

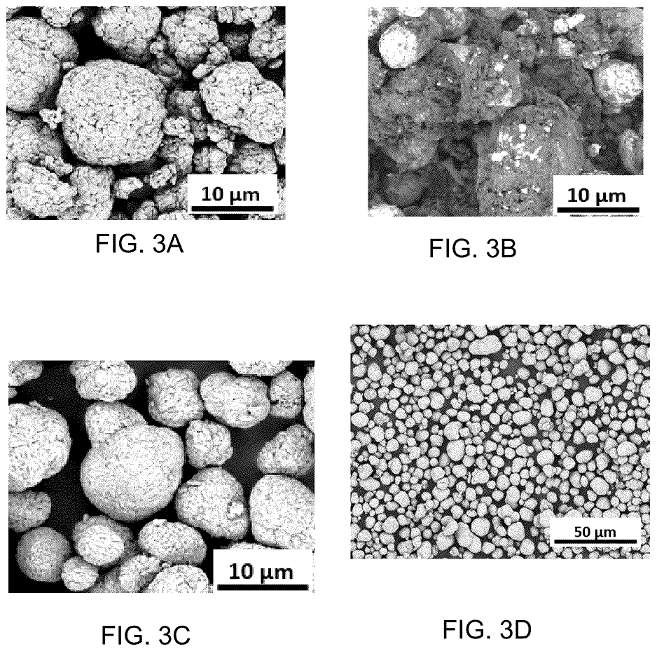

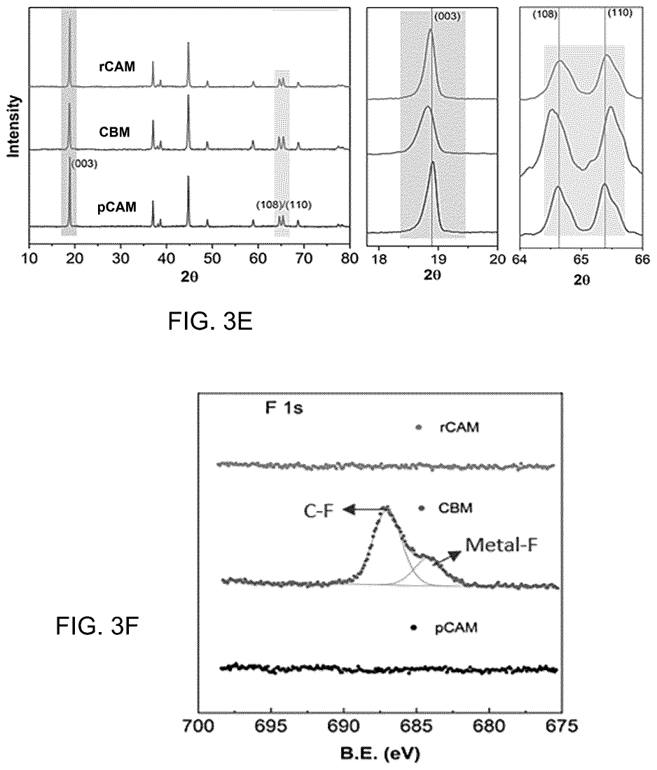

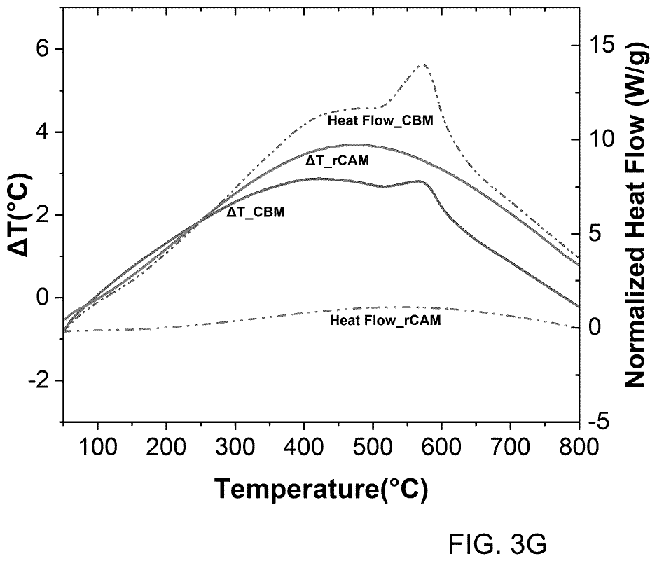

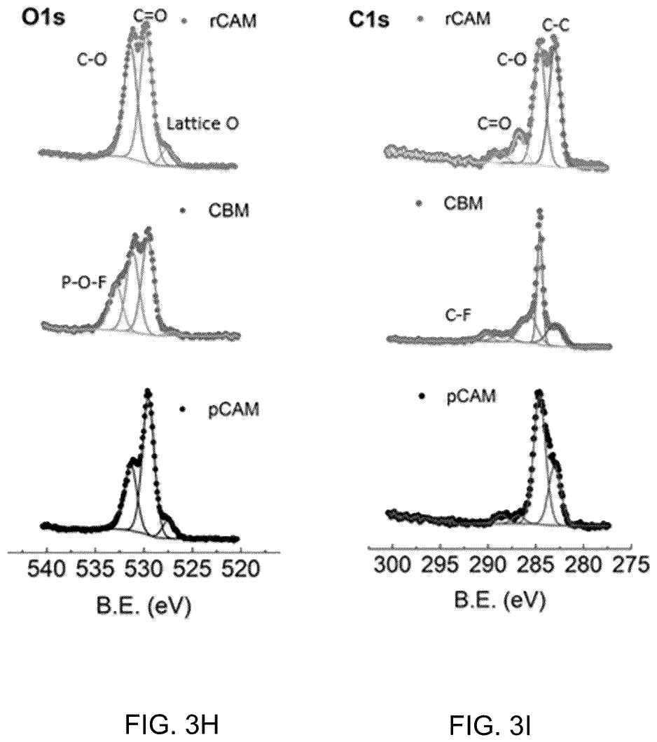

The majority of the carbon impurity is removed after the washing process, which is beneficial for the subsequent annealing process. To provide a direct comparison, FIGS. 3A-C are backscattering mode Scanning Electron Microscope (SEM) images of the pristine CAM (pCAM), the CBM, and the recovered CAM (rCAM), respectively. The CBM shown in FIG. 3B clearly shows that the binder and carbon covers most of the surface of the cathode. This observation corroborates with the TGA data plotted in FIG. 2C showing about 9 wt % presence of total binder and conductive carbon Corresponding differential thermal analysis (DTA) and differential scanning calorimetry (DSC) data are provided in FIG. 3G. The rCAM seen in FIG. 3C exhibits a very clean surface, which implies the success of purification process. Meanwhile, the secondary spherical shape was well preserved, which could help maintain the packing density after electrode casting.

To verify the effectiveness of the relithiation process, both X-ray diffraction pattern (XRD) and inductively coupled mass spectroscopy (ICP-MS) were performed. FIG. 3E provides the XRD patterns for pCAM, CBM, and rCAM. All samples exhibited the α-NaFeO₂ structure with R3̅m space group indicating no phase change in bulk structure during the whole process. As seen in the center panel of FIG. 3E, in CBM, the (003) peak indicative of the c-lattice parameter exhibited a peak shift to the left compared to pCAM, suggesting an increase in the c-lattice constant due to increased electrostatic repulsion between the oxygen layers due to lithium deficiency. As seen in the right panel, compared to the pristine sample, the spacing between the (108)/(110) doublet is larger, indicative of a smaller a-lattice parameter in CBM due to higher oxidation state of nickel (Ni³⁺ instead of Ni²⁺) in a lithium deficient state. In contrast, the (003) peak in rCAM shifts right and the (108)/(110) doublet spacing is reduced, aligning with the pristine sample, indicative of successful relithiation. FIG. 3C also illustrates that the annealing step removes remnant carbon or decomposed binder impurity, leaving the clean and clear morphology of rCAM. The wider SEM image of the rCAM in FIG. 3D highlights the generalized morphology preservation in the inventive process.

X-ray photoelectron spectroscopy (XPS) was performed to track the fluorine on the surface. As shown in FIG. 3F, clear signals from F in binder energy range 680-690 eV observed in CBM, where both C—F bonding and metal-F bonding existed, indicating the presence of both binder and cathode electrolyte interphase (CEI). For rCAM, no fluorine signal was detected as the pCAM, suggesting the successful removal of fluorine element from CBM. FIGS. 3H and 3I provide XPS data for oxygen and carbon, respectively, confirming removal of the cathode electrolyte interphase from the recovered cathode. In FIG. 3H, the O1s from CBM after treatment has a clear TM-O peak around 528 eV, and no peak around 533 eV, further proving the removal of CEI. For C1s, the disappearance of C-F bonding around 290 eV in rCAM sample also verified the PVDF removal.

Transition metal (TM) leaching is a potential reason for degradation of LIBs. To identify the CBM before and after recovery process, ICP-MS was conducted to verify the Ni/Co/Mn ratio and the related results are shown in Table 1.

TABLE 1

| | Li/TM | Ni/TM | Co/TM | Mn/TM |
|---|---|---|---|---|
| | ratio | ratio | ratio | ratio |
| pCAM NCM111 | 1.08 | 0.34 | 0.34 | 0.32 |
| CBM NCM111 | 0.89 | 0.36 | 0.30 | 0.34 |
| rCAM NCM111 | 1.02 | 0.36 | 0.30 | 0.34 |
| pCAM NCM622 | 1.05 | 0.60 | 0.20 | 0.20 |
| CBM NCM622 | 0.91 | 0.61 | 0.20 | 0.19 |
| rCAM NCM622 | 1.07 | 0.61 | 0.20 | 0.19 |

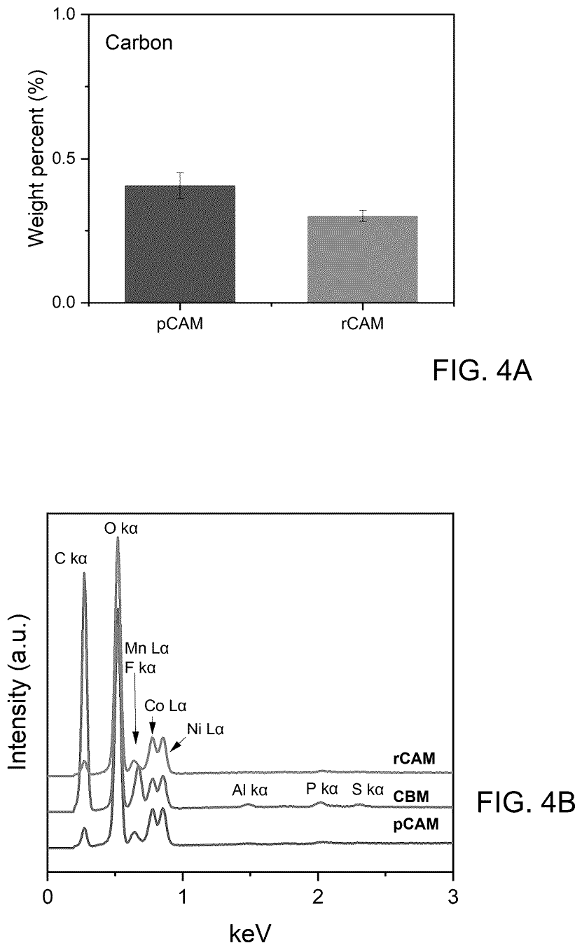

As seen in the table, the TM ratios are the same for both samples and kept constant as the pristine material. Thus, the inventive recovery process preserves the TM stoichiometry, avoiding any leaching. To further evaluate the carbon residual of the samples, combustion element analysis was performed to quantify the carbon from pCAM and rCAM, the results of which are shown in FIG. 4A. The carbon residual weight ratio of rCAM is similar to that of pCAM, further confirming the efficiency of carbon removal. EDS was performed to track the aluminum impurity. Results are shown in FIG. 4B. The signal of aluminum present in the CBM vanished in the rCAM, indicating efficient removal of aluminum impurities.

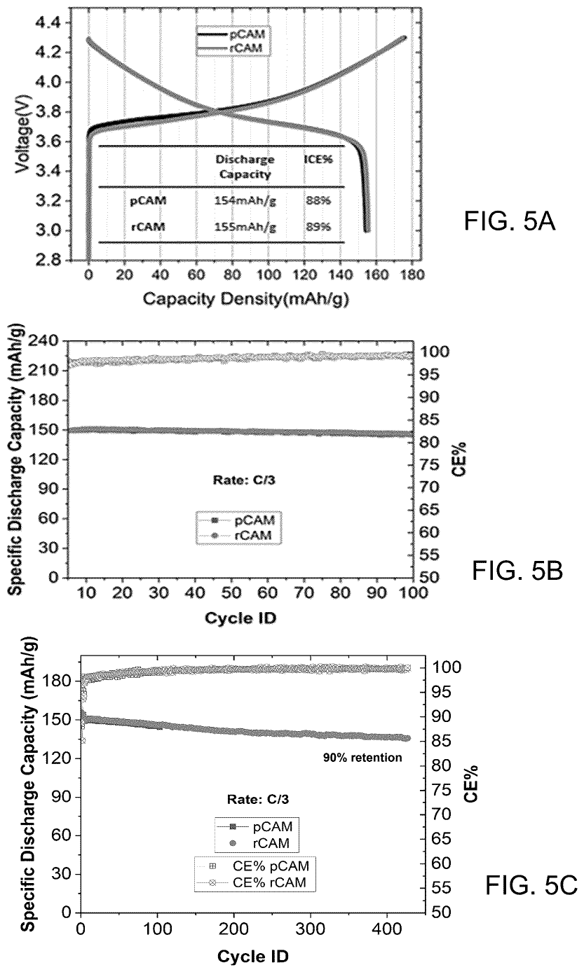

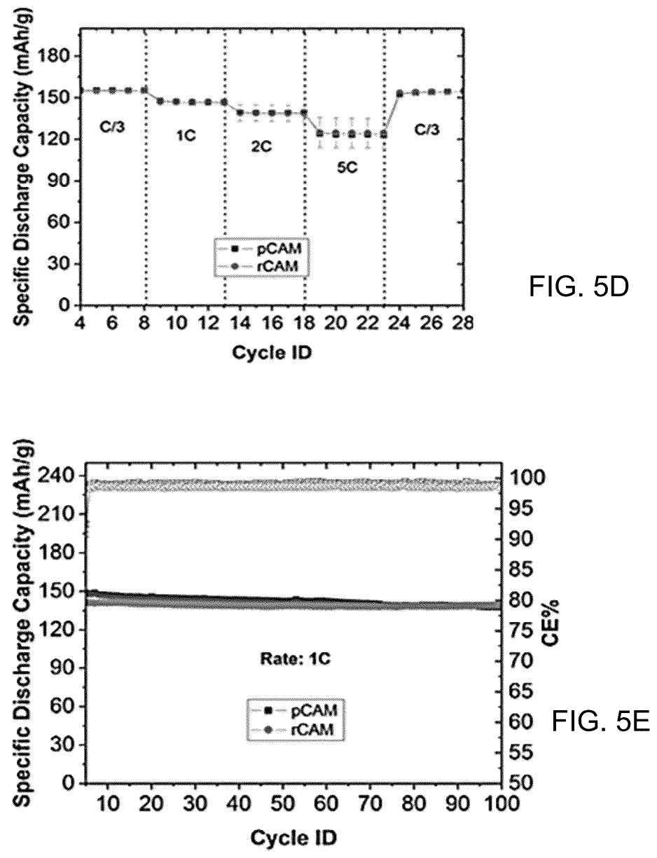

After confirming the impurity removal and quality of rCAM, electrochemical performances were evaluated via half-cell and full cell configurations, the related results are shown in FIGS. 5A-5E. The voltage profile obtained from the first cycle at C/10, shown in FIG. 5A, compares discharge capacity of 155 mAh/g for the rCAM vs 154 mAh/g of the pCAM. The initial coulombic efficiency (ICE %) of rCAM (89%) is so similar to pCAM (88%) that the curves are nearly indistinguishable. Half-cell cycling at C/3 rate illustrates 98% discharge capacity retention after 100 cycles for rCAM, which substantially overlaps the results for pCAM, as shown in FIG. 5B. Longer half-cell cycling of rCAM is shown in FIG. 5C with over 400 cycles and 90% discharge capacity retention, further highlighting the remarkable quality of rCAM, with the results indistinguishable from those of pCAM. The rate performance was evaluated in half cell configuration, and the data is shown in FIG. 5D, with the curves completely overlapping for both samples. The well-matched performance between pCAM and rCAM validates the direct recycling process. Finally, a full cell was assembled using graphite as the anode. FIG. 5E shows a similar trend with capacity retention of more than 94% at 1C after 100 cycles for pCAM and rCAM. Therefore, the rCAM evidently shows competing electrochemical performance as the pCAM in all aspects.

To establish the sustainability feature of the inventive approach, the HT supplement solution was recovered as a supernatant following a one-time process to regenerate new batches of the CBM.

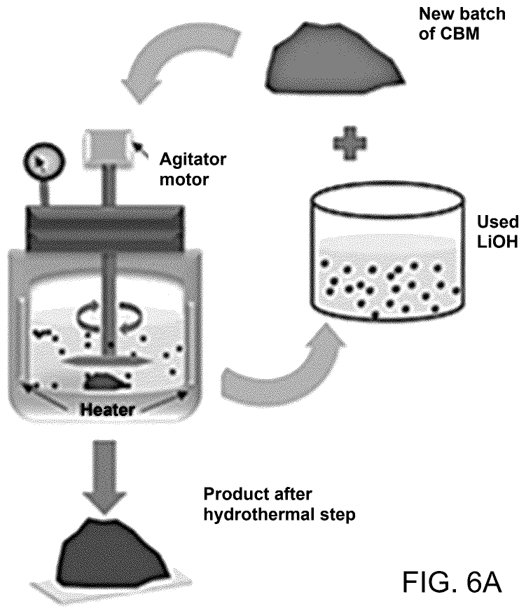

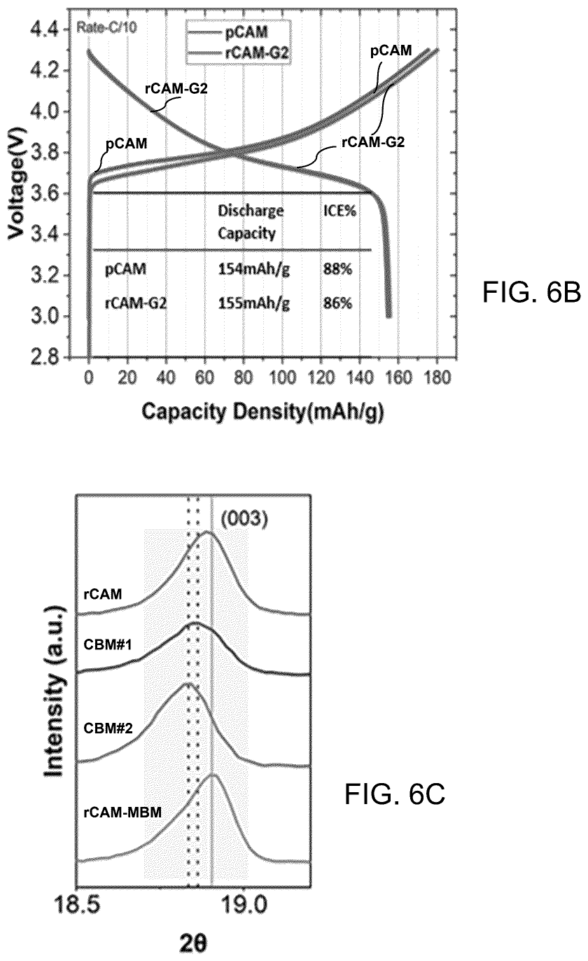

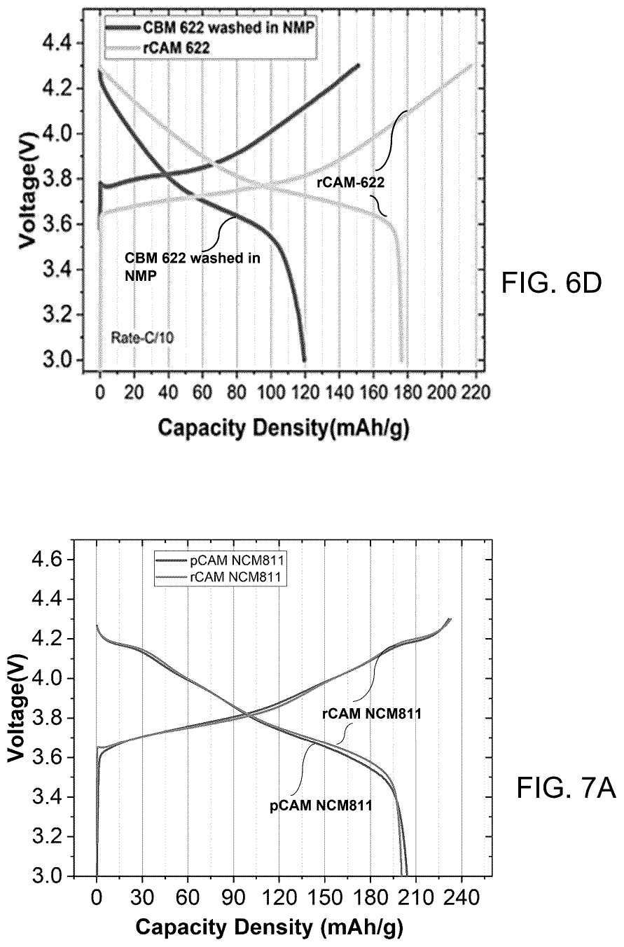

Referring to the process schematic is shown in FIG. 6A, 4M LiOH that had been used as the supplement alkaline solution for the hydrothermal treatment of the 100 g CBM (NCM111) batch was stored. The same solution was used for hydrothermal treatment of an additional batch of CBM, referred to as the “2^{nd} batch”. The CBM post-HT was washed using a copious amount of D.I. water to remove surface alkaline, decomposed PVDF, and carbon impurities. The 2^{nd} batch was dried overnight in a convection oven at 80 °C then mixed with 5 mol % of Li₂CO₃ and annealed in a box furnace for 4 hrs at 850 °C, ramping 5 °C per minute and natural cooling post annealing. The obtained product was labeled “rCAM-G2′” (or rCAM-Generation in 2×-used LiOH). Following the same procedure with the same supplement solution again another product ‘rCAM-G3’ (or rCAM-Generation in 3×-used LiOH) was obtained. The resulting products were used to cast electrodes.

The sample relithiated from the used solution was processed further with the same steps. FIG. 6B shows the voltage profile for the first cycle run at C/10 in half cell configuration. Interestingly, the capacity obtained for this sample i.e., 155 mAh/g, was also similar to pristine, as was the CBM regenerated in the fresh solution. We reused the same LiOH solution multiple times to demonstrate the robustness. The associated XRD analysis and electrochemical performance demonstrate material regeneration with negligible impact of accumulating impurities observed on final product quality. The corresponding energy efficiency comparison between pCAM, rCAM, rCAM-G2 and rCAM-G3 exhibited negligible difference between the samples.

In real life, CBM obtained from EoL cells with various state of health have varying Li deficiency. To show the versatility of our process in treating such CBM mixtures, we mixed NCM111 CBM obtained from two different cells namely, CBM #1 and CBM #2, and mixed them in 1:1 ratio (Mixed Black Mass or MBM) for evaluation. To verify the different Li deficiency, XRD of CBM #1 and CBM #2 was compared with the rCAM. As seen in FIG. 6C, the variation in the (003) peak shift indicated a difference in Li deficiency for CBM #1 and CBM #2. Following the inventive recovery process, the rCAM-MBM exhibited fully recovered Li composition, with the 003-peak shifting back to match pristine NCM111. Furthermore, electrochemical performance was also analyzed to ensure the quality of obtained product where the capacity is consistent with rCAM for several cycles.

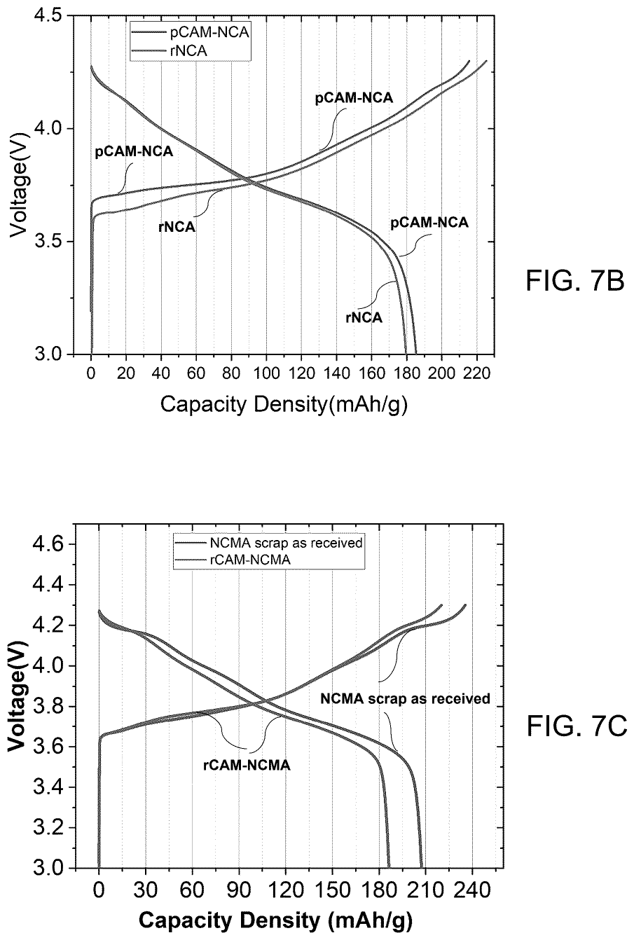

The same direct recycling process was applied to NCM622 CBM (CBM 622). CBM 622 obtained from cycled cells was analyzed by ICP-MS, TGA, and XRD to access the black mass as shown in Table 1. CBM 622 was found to be lithium deficient by ICP-MS and XRD, while TGA suggested 6.5 wt % of PVDF and carbon impurity. CBM 622 was treated with same process as NCM111 CBM apart from annealing step, which was done under pure oxygen flow rather than air flow. Oxygen atmosphere is a critical factor for Ni-rich NCM cathode annealing since they tend to form rock salt phase due to nickel's preferred Ni²⁺ oxidation state and oxygen deficiency. CBM 622 washed in NMP was used as control for this material. The voltage profile for first cycle in half cells made from the recovered NCM622 cathode (rCAM 622) and control CBM 622 washed in NMP are compared in FIG. 6D. The ICE % of the NCM622 CBM half-cell was 79%, possibly due to the impurities, with only 119 mAh/g discharge capacity. ICP-MS and XRD confirmed the lithium deficiency and distorted bulk phase shown in Table 1. In comparison, a half-cell made from rCAM 622 exhibited 82% ICE with 176 mAh/g discharge capacity, which well match the commercial level NCM622. Long-term cycling for the half-cell data demonstrated 94% capacity retention after 200 cycles, indicating the high quality of the regenerated cathode materials. FIG. 7A shows the initial cycle of pristine NCM811 (pCAM NCM811) and recovered NCM811 (rCAM NCM811), where the nearly identical curves indicate successful regeneration. FIG. 7B and FIG. 7C provide similar results for NCA and NCMA materials, respectively.

From a technique perspective, the inventive process bridges the gap between the lab scale direct recycling to industry, taking into account both economic and ecological considerations. The Everbatt model developed by Argonne National Laboratory was used to compare different recycling pathways to highlight the impact that organic solvents have on the direct recycling process economically and ecologically. Many reported processes use NMP (or similar toxic organics) as the solvent to remove the PVDF while others use DMC. A comparison between old pyrometallurgy, currently pursued hydrometallurgy, present lab scale versions of direct recycling (with NMP & DMC), and the inventive organics-free direct recycling method reveals several economic benefits. By avoiding the use of expensive NMP & DMC organics, processing material costs can be reduced by about $5/Kg cell. Beyond the initial material cost of these organic liquids, the general expenses and plant overhead costs arising from their usage including labor, supervision, administrative, and maintenance costs of about $2.16/Kg cell can also be saved. A direct recycling process that relies on organic solvents at an industrial scale would likely be even less profitable than current pyro- and hydro-techniques. Organic solvent-reliant processes are further impractical for scaled up recycling operations since large quantities of toxic materials increases the risk of accidents and environmental damage that can occur at any of a number of stages, including of handling, storage, disposal, and transportation. Thus, the effectiveness of the inventive approach at avoiding these economic and environmental barriers makes it not only practically suitable for ecological scaling but also profitable for business.

Examples: The following examples provide details of procedures used during processing and evaluation of the inventive process.
Example 1: Cathode Black Mass Harvesting: End-of-life prismatic cells (20 Ah) were manually disassembled in a fume hood and a long cathode strip was carefully segregated and dissected into about 5×5 inch pieces. After disassembly, the cathode strips were stored in the fume hood for 2 days and then in a vacuum oven at 80 °C overnight for drying. 100 g CBM of NCM111 as starting material was obtained by blade scratching the cathode strips. Cathode strips for NCM622 were obtained from Argonne National Lab and black mass was blade scratched for the same process. Pristine NCM111 (Toda Kogyo Corp., Japan) or pCAM and NCM622 or ‘pCAM622’ (Targray, Montreal, CA) were used as controls.
Example 2: Cathode Active Material Regeneration: 100 g NMC111 CBM was directly added to a 500 ml autoclave reactor with 300 ml 4M LiOH solution and heated at 220 °C for 4 hrs (Optimizations were obtained from P. Xu, et al., ACS Sustain. Chem. Eng. 2021, 9, 4543, incorporated herein by reference.). After hydrothermal heating, the supernatant was poured out gently and stored for later re-use. DI water was added to the settled product and mechanical agitation was provided by stirring at 500 rpm for 30 minutes. The product was agitated in the DI then filtered using vacuum filtration and washed further with copious amount of water. The product was collected from the filter and dried overnight at 80 °C in a convection oven. The yield until this point was 91 wt. % based on CAM weight. The product was then subjected to grinding with 5 mol % excess Li₂CO₃ and annealed in a box furnace for 4 hours with 5 °C/min ramping to 850 °C and natural cooling. The NCM622 CBM batch was also treated using the same process until the annealing step, which was carried out in a tube furnace under oxygen flow.
Example 3: Mechanism study: 5 wt. % PVDF (KYNAR 2800) binder solution was prepared using NMP as the solvent by stirring the ingredients together overnight. This solution was cast as a thin PVDF membrane over glass using a doctor blade method at a thickness of ~50 μm. After drying, this transparent membrane was easily peeled off using tweezers. A 50 mg section of the PVDF membrane was cut and placed in 4M LiOH solution, then subjected to hydrothermal heating at 220 °C for 4 hrs. (As previously noted, the HT parameters may be varied.) After HT treatment, the membrane turned black and disintegrated into powder. It was washed with DI to remove LiOH and underwent FTIR spectroscopy using a Thermo Scientific Nicolet 6700 FTIR instrument fitted with a Smart iTR diamond ATR fixture. A section of the membrane retained as a control was also subjected to FTIR analysis.
Example 4: Characterization of Black Mass and Regenerate Material: Both CBMs were taken as it is for TGA, DTA, and DSC using SDT650 setup, heated up to 1000 °C at 10 °C/min in air. SEM images were obtained using an FEI Apreo SEM (Thermo Scientific) in backscattering mode. Voltage and current were set to 1 kV and 0.1 nA, respectively. A Rigaku Miniflex XRD setup was used for bulk crystal structure analysis on powder samples. Stoichiometric composition and ratios were calculated using ICP-MS, Thermo Scientific, iCAP RQ model. XPS was performed by Kratos Supra, an Al anode source at 15 kV with a 10⁻⁸ Torr vacuum level was applied for measurement, the step size was 1.0 eV for Survey scans and 0.1 eV for the high-resolution scans. The C Is peak at 284.6 eV was used for calibration.
Example 5: Electrochemical Analysis: Pristine NCM111 was used as the control to compare with the regenerated samples. Typically, cathode powder was mixed with PVDF (KYNAR 2800) and carbon black (Super P65) in NMP (Sigma-Aldrich, anhydrous 99.5%) at a mass ratio 8:1:1 to form a homogeneous slurry. The slurries were cast by a doctor blade and then dried under vacuum at 120 °C overnight. Cathodes discs of 12 mm were cut, calendared, and used to assemble a CR2032 coin cell in an argon environment glovebox with Li metal as an anode. The electrolyte used was battery grade lithium hexafluorophosphate (LiFP₆) solution in ethylene carbonate (EC) and ethyl methyl carbonate (EMC), with the composition of 1.0 M LiPF₆ in EC/EMC=30/70 (v/v) (Gen2, from Gotion, the U.S.). The mass loading was 4-5 mg/cm². For anodes in full cells, graphite (Superior Graphite) was replaced with the cathode powder following the same procedure of mixing with PVDF and NMP at mass ratio 8:1:1. Graphite anode discs cut were 13 mm (active material loading 4-5 mg/cm²) and were prelithiated by direct contact with Li metal for 10 minutes to compensate for future lithium losses during cycling. The cells were rested for 8 hours and then Galvanostatic charge-discharge cycles were tested using a Neware battery cycler between 3-4.3V voltage window with 4 activation cycles at C/10 (1C=155 mA/g) rate and long cycling at C/3 for half-cell and 1C for full cell.

The inventive approach described herein is highly effective for direct recycling of cycled CAM from cathode black mass. All impurities, including PVDF binder, conductive carbon, electrolyte salt, and aluminum shreds are successfully removed. The hydrothermal and washing steps completely remove the fluorine, aluminum, and most conductive carbon residual, while the annealing step helps recover the CAM phase and remove any remaining trace carbon. The process provides 100% recovery of the electrochemical performance of cycled CAM, replicating the performance metrics of pCAM. Direct recycling of the active materials from spent batteries and manufacturing scraps is essential for battery recycling. Prior challenges have hindered direct recycling development and scaling up.

The inventive PRIME process bridges the gap between lab-scale direct recycling and the current industrial recycling methods. PRIME is compatible with both spent batteries and manufacturing scraps. PRIME removes impurities and relithiates the cathode materials with different lithium contents back to the same pristine lithium ratio. Importantly, PRIME provides the ability for scaling to ton-level cathode recovery yield.

1. A method for direct recycling of Li-ion battery cathode material, the method comprising:
hydrothermally treating cathode black mass (CBM) in a lithium ion-containing solution to decompose polyvinylidene fluoride (PVDF) and remove electrolyte salts;
washing the treated CBM in a washing solution to remove extra lithium-ion containing solution, conductive carbon, degraded PVDF and impurities; and
annealing the washed material for crystal structure repair and remnant carbon removal to recover cathode active material (CAM), wherein the CAM is usable to fabricate new batteries.

2. The method of claim 1, wherein the lithium-ion containing solution comprises one or a combination of LiOH, NaOH, KOH, an alkaline metal hydroxide solution, a water-soluble lithium salt, and an electrolyte salt.

3. The method of claim 1, wherein the lithium-ion containing solution comprises an alkaline metal hydroxide solution comprising one or a combination of Li₂CO₃, Li acetate, Li₂SO₄.

4. The method of claim 1, wherein the lithium-ion containing solution comprises an electrolyte salt comprising one or a combination of LiPF₆, LiBF₄, LiClO₄, Lithium bis(oxalato)borate (C₄BLiO₈), and Lithium difluoro(oxalato)borate (C₂BF₂LiO₄).

5. The method of claim 1, wherein the lithium-ion containing solution has a lithium concentration within a range of from 0.1 to saturated at 25 °C.

6. The method of claim 1, wherein the lithium-ion containing solution comprises 0.1 to 5.34M LiOH.

7. The method of claim 1, wherein hydrothermally treating comprises subjecting the CBM in the lithium-ion containing solution to a temperature within a range of 50 to 300 °C for a duration ranging from 1 to 10 hrs.

8. The method of claim 1, wherein washing comprises mechanically agitating the CBM in the washing solution.

9. The method of claim 1, wherein the lithium-ion containing solution comprises recaptured and reused solution from one or more prior hydrothermal treatment.

10. The method of claim 1, wherein the CBM is one or more of NCM111, NCM622, NCM811, NCA, NCMA and mixed CBM.

11. A method for direct recycling of Li-ion battery cathode material, the method comprising:
hydrothermally treating cathode black mass (CBM) in a treatment solution comprising an alkaline solution to decompose polyvinylidene fluoride (PVDF) and remove electrolyte salts and a lithium-ion solution to relithiate the CBM;
washing the treated CBM in a washing solution to remove extra treatment solution, conductive carbon, degraded PVDF and impurities; and
annealing the washed material for crystal structure repair and remnant carbon removal to recover cathode active material (CAM).

12. The method of claim 11, wherein the treatment solution comprises one or a combination of LiOH, NaOH, KOH, an alkaline metal hydroxide solution, a water-soluble lithium salt, and an electrolyte salt.

13. The method of claim 11, wherein the treatment solution comprises an alkaline metal hydroxide solution comprising one or a combination of Li₂CO₃, Li acetate, Li₂SO₄.

14. The method of claim 11, wherein the treatment solution comprises an electrolyte salt comprising one or a combination of LiPF₆, LiBF₄, LiClO₄, Lithium bis(oxalato) borate (C₄BLiO₈), and Lithium difluoro (oxalato) borate (C₂BF₂LiO₄).

15. The method of claim 11, wherein the treatment solution has a lithium concentration within a range of from 0.1 to saturated at 25 °C.

16. The method of claim 11, wherein the treatment solution comprises 0.1 to 5.34M LiOH.

17. The method of claim 11, wherein hydrothermally treating comprises subjecting the CBM in the treatment solution to a temperature within a range of 50 to 300 °C for a duration ranging from 1 to 10 hrs.

18. The method of claim 11, wherein washing comprises mechanically agitating the CBM in the washing solution.

19. The method of claim 11, wherein the treatment solution comprises recaptured and reused solution from one or more prior hydrothermal treatment.

20. The method of claim 11, wherein the CBM is one or more of NCM111, NCM622, NCM811, NCA, NCMA and mixed CBM.
